(19) United States
(12) Patent Application Publication
(10) Pub. No.: US 2016/0087911 A1
(43) Pub. Date: Mar. 24, 2016

(54) NAS CLIENT ACCESS PRIORITIZATION

(71) Applicant: International Business Machines Corporation, Armonk, NY (US)

(72) Inventors: Michael Diederich, Mainz (DE); Thorsten Muehge, Budenheim (DE); Erik Rueger, Ockenheim (DE); Lance W. Russell, Rosanky, TX (US); Rainer Wolafka, Hofheim am Taunus (DE)

(21) Appl. No.: 14/490,715

(22) Filed: Sep. 19, 2014

(51) Int. Cl. H04L 12/911; G06F 17/30; H04L 12/927; H04L 12/26

(52) U.S. Cl. CPC H04L 47/74; H04L 43/16; G06F 17/30197; H04L 47/805

(57) ABSTRACT

Client access prioritization is provided. A plurality of network addresses is assigned to a node of a network-attached storage cluster. A request to access a resource stored by the network-attached storage cluster and accessible to the node is received, wherein the request identifies a network address of the plurality of network addresses. A priority of the request is determined based, at least in part, on the network address identified by the request and further based, at least on part, on a protocol of the request. The request is processed based, at least in part, on the priority of the request.

### BACKGROUND OF THE INVENTION

The present invention relates generally to the field of network-attached storage, and more particularly to network-attached storage client access prioritization.

A clustered file system is a file system that is shared by being simultaneously mounted on multiple servers. Clustered file systems can provide features like location-independent addressing and redundancy which improve reliability or reduce the complexity of the other parts of the cluster. Parallel file systems are a type of clustered file system that spread data across multiple storage nodes, usually for redundancy or performance.

Network attached storage (NAS) is file-level computer data storage connected to a computer network providing data access to a heterogeneous group of clients. NAS not only operates as a file server, but is specialized for this task either by its hardware, software, or configuration of those elements. NAS is often manufactured as a computer appliance, a specialized computer built from the ground up for storing and serving files, rather than simply a general purpose computer being used for the role. A NAS cluster consists of a collection of nodes that have access to the shared storage backend. Each node in the cluster that has connectivity to the external (client) network can be used to provide access to the clients. Typically such a node has multiple network interface cards (NICs) hosting multiple external internet protocol (IP) addresses.

NAS systems are networked appliances which contain one or more hard drives, often arranged into logical, redundant storage containers or redundant array of independent disks (RAID). Network-attached storage removes the responsibility of file serving from other servers on the network. They typically provide access to files using network file sharing protocols such as network file system (NFS), server message block (SMB), or a version of SMB known as common Internet file system (CIFS).

### SUMMARY

According to one embodiment of the present disclosure, a method for client access prioritization is provided. The method includes assigning, by one or more processors, a plurality of network addresses to a node of a network-attached storage cluster; receiving, by one or more processors, a request to access a resource that is stored by the network-attached storage cluster and that is accessible to on the node, wherein the request identifies a network address of the plurality of network addresses; determining, by one or more processors, a priority of the request based, at least in part, on the network address identified by the request and further based, at least on part, on a protocol of the request; and processing, by one or more processors, the request based, at least in part, on the priority of the request.

According to another embodiment of the present disclosure, a computer program product for client access prioritization is provided. The computer program product comprises a computer readable storage medium and program instructions stored on the computer readable storage medium. The program instructions include program instructions to assign a plurality of network addresses to a node of a network-attached storage cluster; program instructions to receive a request to access a resource that is stored by the network-attached storage cluster and that is accessible to on the node, wherein the request identifies a network address of the plurality of network addresses; program instructions to determine a priority of the request based, at least in part, on the network address identified by the request and further based, at least on part, on a protocol of the request; and program instructions to process the request based, at least in part, on the priority of the request.

According to another embodiment of the present disclosure, a computer system for client access prioritization is provided. The computer system includes one or more computer processors, one or more computer readable storage media, and program instructions stored on the computer readable storage media for execution by at least one of the one or more processors. The program instructions include program instructions to assign a plurality of network addresses to a node of a network-attached storage cluster; program instructions to receive a request to access a resource that is stored by the network-attached storage cluster and that is accessible to on the node, wherein the request identifies a network address of the plurality of network addresses; program instructions to determine a priority of the request based, at least in part, on the network address identified by the request and further based, at least on part, on a protocol of the request; and program instructions to process the request based, at least in part, on the priority of the request.

### BRIEF DESCRIPTION OF THE DRAWINGS

FIG. 1 is a functional block diagram illustrating a network storage environment, in accordance with an embodiment of the present disclosure;

FIG. 2 is a flowchart depicting operations for client access prioritization, on a computing device within the network storage environment of FIG. 1, in accordance with an embodiment of the present disclosure;

FIG. 3 is a flowchart depicting operations for performance monitoring, on a computing device within the network storage environment of FIG. 1, in accordance with an embodiment of the present disclosure; and

FIG. 4 is a block diagram of components of a computing device executing operations for client access prioritization, in accordance with an embodiment of the present disclosure.

### DETAILED DESCRIPTION

An embodiment of the present invention provides client access prioritization in a clustered file system. In one embodiment, internet protocol (IP) addresses are assigned to nodes of a cluster. The IP addresses are assigned from a plurality of sets of IP addresses. Each such set, and each IP address thereof, corresponds to a priority level. In this embodiment, a client device requests accesses to a node according to a particular protocol. The node to which the client device requests access has an assigned IP address. The client access is prioritized based, in various embodiments, on the IP address of the node, the priority level of the IP address, the protocol of the request, or a combination thereof.

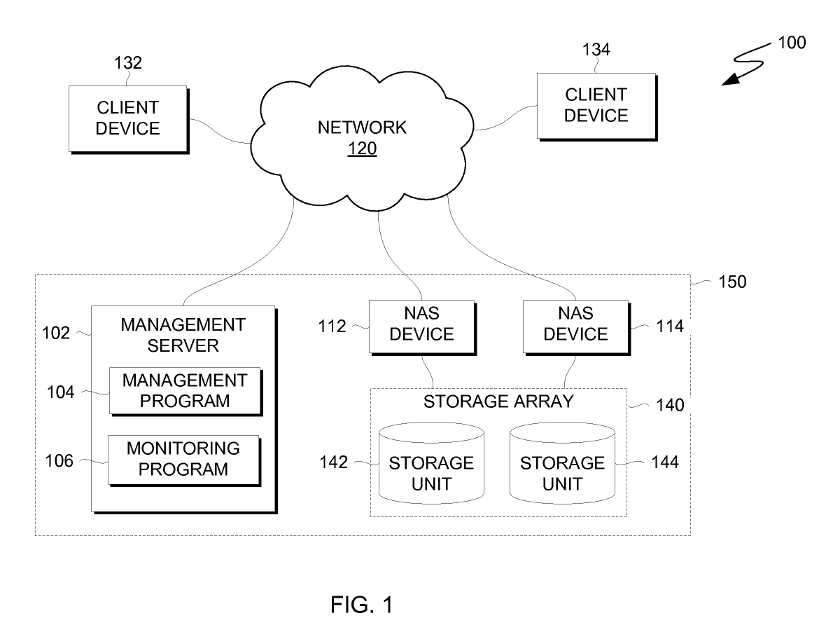

The present disclosure will now be described in detail with reference to the Figures. FIG. 1 is a functional block diagram illustrating a network storage environment, in accordance with an embodiment of the present disclosure. For example, FIG. 1 is a functional block diagram illustrating network storage environment 100. Network storage environment 100 includes client device 132, client device 134, and network attached storage (NAS) cluster 150, which includes management server 102, NAS device 112, NAS device 114, all of which are connected over network 120. NAS cluster 150 also includes storage array 140, which includes storage unit 142, and storage unit 144, which is connected to network 120 via each of NAS device 112 and NAS device 114. Management server 102 includes management program 104 and monitoring program 106.

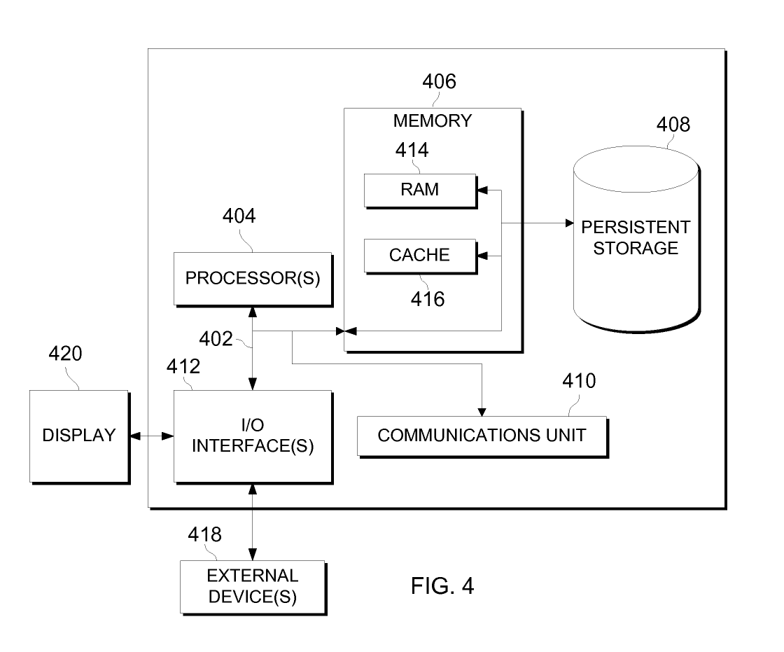

In various embodiments of the present invention, each of management server 102, client device 132, and client device 134 is a computing device that can be a standalone device, a server, a laptop computer, a tablet computer, a netbook computer, a personal computer (PC), or a desktop computer. In another embodiment, each of management server 102, client device 132, and client device 134 represents a computing system utilizing clustered computers and components to act as a single pool of seamless resources. In general, each of management server 102, client device 132, and client device 134 can be any computing device or a combination of devices with access to one another and to NAS cluster 150 (including at least NAS devices 112 and 114). In general, management server 102 can be any computing device or combination of devices with access to and/or capable of executing management program 104 and monitoring program 106. Management server 102 may include internal and external hardware components, as depicted and described in further detail with respect to FIG. 4. In one embodiment, management server 102 is a proxy server through which NAS devices 112 and 114 connect to network 120. In another embodiment, management server 102 is a domain name system (DNS) server (or, alternatively, a server including DNS functionality). In one embodiment, management server 102 is a management node of NAS cluster 150, which is a node of NAS cluster 150 that manages other nodes of NAS cluster 150.

In this exemplary embodiment, each of management program 104 and monitoring program 106 is stored on management server 102. In other embodiments, each of management program 104 and monitoring program 106 may reside on another computing device, provided that each of management program 104 and monitoring program 106 can access and is accessible by management server 102, client devices 132 and 134, and NAS devices 112 and 114 of NAS cluster 150. In one example, management program 104 and monitoring program 106 reside on each of one or more nodes of NAS cluster 150, such as one or more of NAS device 112 and NAS device 114. In this example, the instances of management program 104 and monitoring program 106 coordinate to accomplish the functionality described herein. In another embodiment, management program 104 and monitoring program 106 reside on a node of NAS cluster 150 that is designated as a management node. In yet other embodiments, each of management program 104 and monitoring program 106 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between management server 102, client device 132, client device 134, NAS device 112, and NAS device 114, in accordance with a desired embodiment of the present invention.

Management program 104 operates to prioritize access of one or more clients (e.g., client device 132, client device 134) to a NAS device (e.g., NAS device 112, NAS device 114). In one embodiment, management program 104 receives at least one set of addresses. Management program 104 assigns addresses to NAS devices. Management program 104 receives an access request from a client. Management program 104 determines a priority of the request. Management program 104 processes the request. For example, management program 104 receives two sets of IP addresses. In this example, management program 104 assigns the IP addresses to a node, such as NAS device 112, of a NAS cluster, such as NAS cluster 150. Further, management program 104 receives requests from clients to access the storage units and processes the requests. In various embodiments, management program 104 processes an access request by providing access to a requested resource, by postponing the request, or by denying the request.

Monitoring program 106 operates to monitor performance conditions of a NAS cluster. In one embodiment, monitoring program 106 monitors performance conditions of one or more NAS devices (e.g., NAS device 112, NAS device 114). Monitoring program 106 determines if the performance conditions violate one or more performance thresholds. If monitoring program 106 determines that the performance conditions violate the performance thresholds, then monitoring program 106 performs one or more corrective actions.

In one embodiment, each of NAS device 112 and NAS device 114 are nodes of NAS cluster 150 that management server 102 (via management program 104) selectively allows client devices 132 and 134 to access. Each of NAS device 112 and NAS device 114 accesses storage array 140, which is a storage backend of NAS cluster 150. Storage array 140 includes one or more storage units, such as storage unit 142 and storage unit 144. Storage array 140 stores one or more resources. For example, storage unit 142 stores resources including text data, audio data, video data, or a combination thereof. Each node of NAS cluster 150 is connected to network 120 via one or more network adapters. The one or more network adapters include physical network adapters, virtual network adapters, or both. In one embodiment, each node of NAS cluster 150 is accessible via network 120 via one or more IP addresses. In one embodiment, a client device (e.g., client device 132, client device 134) accesses a NAS device (e.g., NAS device 112, NAS device 114) by requesting access to a resource stored in one or more storage units (e.g., storage unit 142, storage unit 144) of storage array 140. In various embodiments, the request complies with a protocol such as NFS, SMB, or CIFS.

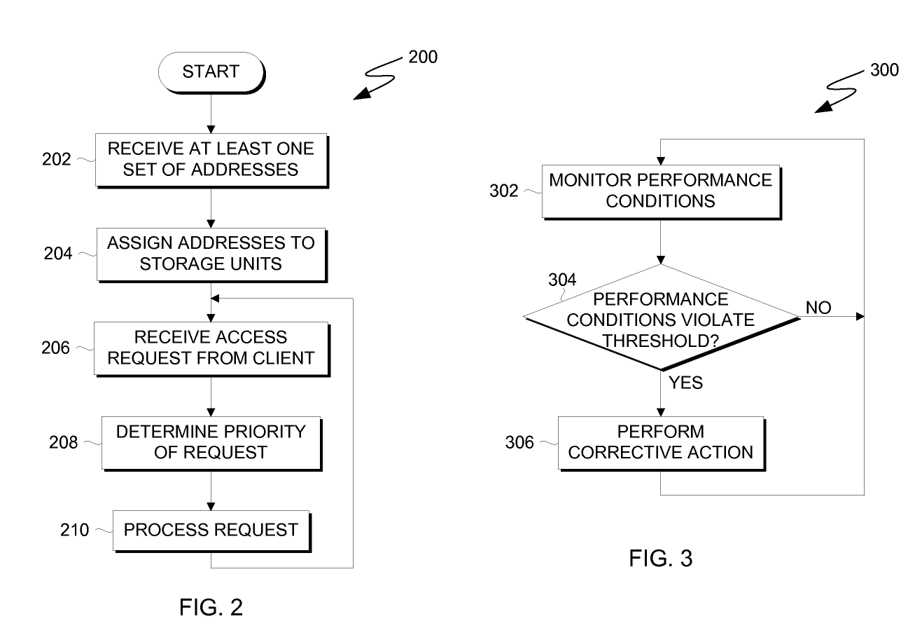

FIG. 2 is a flowchart depicting operations for client access prioritization, on a computing device within the network storage environment of FIG. 1, in accordance with an embodiment of the present disclosure. For example, FIG. 2 is a flowchart depicting operations 200 of management program 104, on management server 102 within network storage environment 100.

In operation 202, management program 104 receives at least one set of addresses. In one embodiment, the addresses are network addresses of network 120. In one embodiment, each set of addresses includes one or more IP addresses. In various examples, the set of addresses includes one or more public IP addresses, one or more private IP addresses, or a combination thereof.

In one embodiment, each set of addresses corresponds to a priority level. Further, each address of a set corresponds to the priority level of the set that includes the address. In one embodiment, management program 104 receives a plurality of sets of addresses, wherein each set of addresses corresponds to a priority level. In this case, sets of addresses correspond to the same priority level or a different priority level relative to other sets of addresses. For example, management program 104 receives a first set of addresses having a high priority level and a second set of addresses having a low priority level. In one embodiment, there are two priority levels (e.g., a high priority level and a low priority level). In another embodiment, there are more than two priority levels. For example, management program 104 receives one or more sets of addresses corresponding to a first priority level, one or more sets of addresses corresponding to a second priority level, and one or more sets of addresses corresponding to a third priority level. In this case, the priority levels are ranked such that each is higher or lower relative to each other.

In one embodiment, management program 104 receives the sets of addresses from a user. The user is, in various examples, a user of management server 102, client device 132, or client device 134. In some embodiments, management program 104 generates the sets of addresses. In one such embodiment, management program 104 generates a first and a second set of addresses by portioning an available range of IP addresses (as determined by, for example, a DNS server or DNS software operating on management server 102) into first and second portions. In another such embodiment, management program 104 generates sets of addresses from the addresses that are already assigned to the nodes of NAS cluster 150 (e.g., NAS device 112 and NAS device 114).

In one embodiment, management program 104 receives a priority level of each set of addresses from a user. In some embodiments, management program 104 generates a priority level of each set of addresses. In one such embodiment, management program 104 generates a priority level by algorithmically determining the priority level. For example, management program 104 assigns sequentially higher priority levels to each set of addresses received. In another example, management program 104 randomly (or, alternatively, pseudo-randomly) assigns priority levels to each set of addresses. In yet another embodiment, management program 104 assigns priority levels to each set of addresses according to a pre-determined sequence or priority level mapping.

In one embodiment, each set of IP addresses includes one or more public IP addresses. Each such public IP address is an address at which a client device accesses a NAS device to which the IP address is assigned (see operation 204). For example, a user of client device 134 accesses NAS device 112 via network 120 by requesting access to NAS device 112 from management server 102. In this case, the request of client device 134 identifies NAS device 112 by an IP address assigned to NAS device 112.

In operation 204, management program 104 assigns one or more addresses to one or more NAS devices. In one embodiment, the one or more NAS devices are nodes of a NAS cluster. For example, management program 104 assigns one or more public IP addresses to each of NAS device 112 and NAS device 114, which are nodes of NAS cluster 150. In some embodiments, management program 104 assigns addresses to the NAS devices when the NAS devices are under a low load. In other embodiments, management program 104 assigns addresses to the NAS device in response to a user specification.

In one embodiment, management program 104 assigns at least one address to each NAS device. In this case, management program 104 assigns the address from the at least one set of addresses received. For example, management program 104 assigns an IP address to NAS device 112 and an IP address to NAS device 114. In one embodiment, management program 104 assigns a public address to each NAS device. In another embodiment, management program 104 assigns an address for each network adapter of each NAS device. In yet another embodiment, management program 104 assigns a plurality of addresses to each NAS device.

In one embodiment, management program 104 assigns addresses from each set of addresses according a specified proportion. The specified proportion is, in various examples, user-specified, algorithmically determined, or pre-configured. For example, management program 104 receives two sets of addresses. In this example, given a proportion of one-to-one, management program 104 assigns addresses to a NAS device in the proportion of half from the first set of addresses and half from the second set of addresses. Alternatively, given a proportion of two-to-one, management program 104 assigns two addresses from one set of addresses for every one address of the other set of addresses. In one embodiment, management program 104 assigns to each NAS device an equal number of addresses from each set of addresses (i.e., one-to-one). In a simple example, management program 104 receives a high priority set of addresses and a low priority set of addresses, each of which includes two addresses. In this case, management program 104 assigns one high-priority address and one low priority address to each of NAS device 112 and NAS device 114. In one embodiment, management program 104 assigns a minimum number (e.g., one) of addresses from each set of addresses to each NAS device.

In some embodiments, management program 104 assigns addresses according to a proportion that is specified per NAS device. For example, management program 104 assigns addresses such that a first NAS device has high priority addresses and a second NAS device has low priority addresses. In another example, management program 104 receives a first, second, and third set of addresses. In this example, management program 104 assigns addresses to a first NAS device and a second NAS device. A proportion specified for the first NAS device is two to one to zero for the first, second, and third sets, respectively. A proportion specified for the second NAS device is one to two to one for the first, second, and third sets, respectively. Management program 104 assigns addresses to the first NAS device and the second NAS device from the first set, the second set, and the third set in proportions consistent with the respective specified proportions for the first NAS device and second NAS device.

In operation 206, management program 104 receives an access request from a client. The access request is a request from a client to access a storage resource residing in a storage unit (e.g., storage unit 142, storage unit 144). In one embodiment, management program 104 receives the access request from a client device (e.g., client device 132, client device 134).

In one embodiment, the received access request follows a particular communications protocol. For example, the request follows network file system (NFS) protocol. In another example, the request follows common internet file system (CIFS) protocol. As is discussed more fully below, each protocol is prioritized with respect to each other protocol.

In one embodiment, the received access request identifies an address of a node of NAS cluster 150. For example, the access request received from a client requests a first resource. In this example, the request identifies an address of NAS device 112, which is a node of NAS cluster 150 that has access to the storage array (and the storage unit thereof) in which the requested resource resides. In another embodiment, the received access request does not identify an address of a NAS device, which situation is discussed in further detail below.

In operation 208, management program 104 determines a priority of the request. In one embodiment, management 104 determines the priority of the request based, at least in part, on a protocol of the request, a priority level of a protocol of the request, an IP address of a NAS device identified by the request, a priority level of an IP address identified by the request, or a combination thereof.

In one embodiment, the access request identifies a node of NAS cluster 150 (e.g., NAS device 122, NAS device 124). For example, the access request identifies a NAS device by requesting a storage resource accessible to the NAS device that is stored on one or more storage units of storage array 140. In this case, management program 104 resolves the request to an address (e.g., IP address) of a NAS device that has access to the requested resource. As discussed previously, each NAS device has at least one address, each of which has a priority level. Thus, the address to which management program 104 resolves the request has a priority level. In one embodiment, management program 104 resolves the request to an address having a priority level that corresponds to the protocol of the request.

In one embodiment, the received access request identifies an address of a node of NAS cluster 150. For example, the address is assigned to NAS device 114, which is a node of NAS cluster 150 and which has access to storage array 140. In this embodiment, the address has a priority level. For example, the priority level of an address corresponds to the set of addresses in which it is included.

In some embodiments, the received access request does not identify an address of a node of NAS cluster 150. In one such embodiment, the request identifies the resource by an identifier other than an address. For example, the request identifies the resource by a host name (or machine name), following a protocol such as network basic input/output system (NetBIOS), uniform naming convention (UNC), or other similar naming protocol. In this case, management program 104 resolves the host name to an address. In one embodiment, management program 104 associates the request with the address to which the host name resolves. For example, management program 104 modifies the request to identify the address. In another embodiment, management program 104 processes the request as though the request identifies the address to which the host name resolves.

In yet another embodiment, management program 104 associates the request with an address based on the protocol of the request. For example, a first client and a second client each request a resource residing on a first storage unit via NAS device 112. In this example, NAS device 112 has low priority addresses and high priority addresses. A first access request from the first client requests the resource utilizing NFS protocol. A second access request from the second client requests the resource utilizing CIFS protocol. In this example, NFS protocol and CIFS protocol have a high and low priority level, respectively. Management program 104 associates the first request with an address of NAS device 112 that has a high priority level. Management program 104 associates the second request with an address of NAS device 112 that has a low priority level. In one embodiment, management program 104 stores a mapping of protocols to priority levels. The mapping is user-specified, algorithmically determined, or pre-determined. For example, management program 104 receives the mapping from a user of management server 102.

In operation 210, management program 104 processes the request. In one embodiment, management program 104 processes the request by fulfilling the request, postponing the request, denying the request, or discarding the request. In one embodiment, management program 104 processes a request by fulfilling the request. That is, management program 104 provides a client device access to a requested storage resource. For example, management program 104 receives from client device 132 a request for access to a resource stored in storage unit 144. Management program 104 prioritizes the request (see operation 208) as high priority based on the request identifying an IP address of a node of NAS cluster 150 and following a protocol, wherein each of the IP address and the protocol have a high priority level. Management program 104 fulfills the request by providing client device 132 access to the resource stored in storage unit 144, for example by forwarding the request to a node of NAS cluster 150 that is assigned the IP address identified by the request.

In another embodiment, management program 104 processes a request by postponing the request. That is, management program 104 queues the request for later fulfillment, denial, or discarding. For example, management program 104 processes a request by adding the request to a queue of other requests to be processed. In yet another embodiment, management program 104 processes the request by denying or discarding a client device access to a requested storage resource. For example, management program 104 denies or discards a low priority request in order to avoid negatively impacting a quality of service of higher priority requests.

FIG. 3 is a flowchart depicting operations for performance monitoring, on a computing device within the network storage environment of FIG. 1, in accordance with an embodiment of the present disclosure. For example, FIG. 3 is a flowchart depicting operations 300 of monitoring program 106, on management server 102 within network storage environment 100.

In operation 302, monitoring program 106 monitors performance conditions. In one embodiment, monitoring program 106 monitors performance conditions of the NAS cluster. Performance conditions include various metrics and statistics that measure the performance and load of the NAS cluster. Performance conditions include load measures, resource utilization measures, and service measures. Load measures include measures of, for example, requests received per measurement interval and requests processed per measurement interval. Resource utilization measures include measures of, for example, memory usage, processor usage, and network adapter utilization. Service measures include measures of, for example, the speed with which requests are processed and requests fulfilled, postponed, denied, or discarded. In one embodiment, monitoring program 106 monitors performance conditions by node of NAS cluster 150 and by priority level. In another embodiment, monitoring program 106 monitors performance conditions for a cluster (e.g., by aggregating performance conditions of each NAS device of the cluster). For example, monitoring program 106 monitors performance conditions for a cluster of NAS devices, for each NAS device (i.e., node) of the cluster, and for requests of each priority level processed by each NAS device of the cluster.

In decision 304, monitoring program 106 determines whether the performance conditions of the NAS cluster violate one or more performance thresholds. In one embodiment, monitoring program 106 compares each of the performance conditions to one or more performance thresholds. Monitoring program 106 determines that the performance conditions of the NAS cluster violate one or more performance thresholds based on, in various embodiments, whether any of the performance conditions violate one or more performance thresholds, whether certain of the performance conditions violate certain of the performance thresholds, or whether a predetermined count of the performance conditions violate a predetermined count of the performance thresholds.

In some embodiments, monitoring program 106 determines whether performance conditions violate performance thresholds based on the performance conditions of requests having a certain priority level. For example, monitoring program 106 monitors performance conditions including a processing time of high priority requests and a processing time of low priority requests. In this case, monitoring program 106 compares the performance conditions to performance thresholds and determines that the processing time of high priority requests is within the performance thresholds and that the processing time of low priority requests are above the performance thresholds. In response to determining that the performance conditions for the high priority requests does not violate the performance thresholds, monitoring program 106 determines that the performance conditions do not violate the performance thresholds.

In some embodiments, the performance thresholds for a first priority level are determined based, at least in part, on the performance conditions of a second priority level. For example, monitoring program 106 determines the performance thresholds of a lower priority level based on the performance conditions of a higher priority level to ensure that the performance conditions of the higher priority requests meet or exceed performance conditions of the lower priority requests. In such an example, if the performance conditions of the lower priority requests violate the performance thresholds for those requests, then monitoring program 106 reduces the available performance to process those requests, such as by reassigning NAS devices from processing lower priority requests to higher priority requests, or by shifting available processing power or other computing resources from processing the lower priority requests to processing the higher priority requests.

If monitoring program 106 determines that the performance conditions violate the performance thresholds (decision 304, YES branch), then monitoring program 106 performs one or more corrective actions (operation 306). If monitoring program 106 determines that the performance conditions do not violate the performance thresholds (decision 304, NO branch), then monitoring program 106 returns to monitoring performance conditions (operation 302).

In operation 306, monitoring program 106 performs one or more corrective actions. In some embodiments, corrective actions include adjusting an amount of computing resources (e.g., processor availability, memory space, thread or process priority) that is allocated to processing requests to a certain set of addresses. In one example, monitoring program 106 limits or reduces computing resources allocated for processing requests to a first set of addresses. In another example, monitoring program 106 increases computing resources allocated for processing requests of a second set of addresses. Monitoring program 106 adjusts the computing resources allocated for processing requests by mechanisms such as utilization limit adjustments (e.g., via a ulimit command), memory clipping, intended reply delay, and the like.

In some embodiments, corrective actions include reassigning addresses of NAS devices. In one such embodiment, monitoring program 106 reassigns an address of a NAS device to another NAS device. For example, monitoring program 106 reassigns addresses of the NAS devices of NAS cluster 150 by assigning all addresses of a set of addresses, such as a low priority set of addresses, to a subset of the NAS devices. The size of this subset of NAS devices relative to the total number of NAS devices of the cluster is user-specified, algorithmically determined, pre-configured, or a combination thereof. In another such embodiment, monitoring program 106 reassigns an address of a NAS device by un-assigning an address from a first set of addresses and assigning an address to the NAS device from a second set of addresses. For example, monitoring program 106 un-assigns a low priority address from a NAS device and assigns a high priority address in its place.

In some embodiments, corrective actions include terminating a client connection. In one such embodiment, monitoring program 106 performs one or more other corrective actions before terminating a client connection. For example, monitoring program 106 adjusts computing resources for processing requests, determines that the performance conditions still violate the performance thresholds, and then terminates a client connection. In one embodiment, monitoring program 106 determines that performance conditions of higher priority requests violate performance thresholds and, in response, monitoring program 106 terminates one or more client connections to lower priority addresses. In one embodiment, only connections to low priority addresses are eligible for termination. In other words, monitoring program 106 does not terminate connections to high priority addresses as a corrective measure.

FIG. 4 is a block diagram of components of the computing device executing operations for client access prioritization, in accordance with an embodiment of the present disclosure. For example, FIG. 4 is a block diagram of management server 102 within network storage environment 100 executing operations of each of management program 104 and monitoring program 106.

It should be appreciated that FIG. 4 provides only an illustration of one implementation and does not imply any limitations with regard to the environments in which different embodiments may be implemented. Many modifications to the depicted environment may be made.

Management server 102 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Each of management program 104 and monitoring program 106 is stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Each of management program 104 and monitoring program 106 may be downloaded to persistent storage 408 through communications unit 410.

I/O interface(s) 412 allows for input and output of data with other devices that may be connected to management server 102. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention (e.g., management program 104, monitoring program 106) can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for client access prioritization, the method comprising:
assigning, by one or more processors, a plurality of network addresses to a node of a network-attached storage cluster;
receiving, by one or more processors, a request to access a resource that is stored by the network-attached storage cluster and that is accessible to on the node, wherein the request identifies a network address of the plurality of network addresses;
determining, by one or more processors, a priority of the request based, at least in part, on the network address identified by the request and further based, at least on part, on a protocol of the request; and
processing, by one or more processors, the request based, at least in part, on the priority of the request.

2. The method of claim 1, further comprising:
monitoring, by one or more processors, a performance condition of the node; and
determining, by one or more processors, that the performance condition of the node violates a performance threshold and, in response, performing, by one or more processors, a corrective action.

3. The method of claim 2, wherein the corrective action includes at least one of: adjusting an allocation of computing resources of the node from processing requests that identify a network address of the plurality of a first set of network addresses to processing requests that identify a network address of a second set of network addresses, re-assigning at least one of the plurality of network addresses of the node, and terminating a connection by which the request was received.

4. The method of claim 1, wherein the plurality of network addresses includes at least one network address from a first set of network addresses and at least one network address from a second set of network addresses, wherein the first and second sets of network addresses are disjoint.

5. The method of claim 4, wherein the first set of network addresses has a first priority level and the second set of network addresses has a second priority level, wherein the first priority level is a higher priority than the second priority level.

6. The method of claim 1, wherein processing the request further comprises at least one of: providing access to the resource, queueing the request, denying access to the resource, or discarding the request.

7. The method of claim 1, further comprising:
identifying, by one or more processors, the protocol of the request, wherein the protocol is network file system, server message block, or common Internet file system protocol.

8. The method of claim 1, wherein each of the network addresses is an internet protocol address.

9. A computer program product for client access prioritization, the computer program product comprising:
a computer readable storage medium and program instructions stored on the computer readable storage medium, the program instructions comprising:
program instructions to assign a plurality of network addresses to a node of a network-attached storage cluster;
program instructions to receive a request to access a resource that is stored by the network-attached storage cluster and that is accessible to on the node, wherein the request identifies a network address of the plurality of network addresses;
program instructions to determine a priority of the request based, at least in part, on the network address identified by the request and further based, at least on part, on a protocol of the request; and
program instructions to process the request based, at least in part, on the priority of the request.

10. The computer program product of claim 9, wherein the program instructions further comprise:
program instructions to monitor a performance condition of the node; and
program instructions to determine that the performance condition of the node violates a performance threshold and, in response, perform a corrective action.

11. The computer program product of claim 10, wherein the program instructions to perform the corrective action include at least one of: program instructions to adjust an allocation of computing resources of the node from processing requests that identify a network address of the plurality of a first set of network addresses to processing requests that identify a network address of a second set of network addresses, program instructions to re-assign at least one of the plurality of network addresses of the node, and program instructions to terminate a connection by which the request was received.

12. The computer program product of claim 9, wherein the plurality of network addresses includes at least one network address from a first set of network addresses and at least one network address from a second set of network addresses, wherein the first and second sets of network addresses are disjoint.

13. The computer program product of claim 12, wherein the first set of network addresses has a first priority level and the second set of network addresses has a second priority level, wherein the first priority level is a higher priority than the second priority level.

14. The computer program product of claim 9, wherein the program instructions to process the request further comprise at least one of: program instructions to provide access to the resource, program instructions to queue the request, program instructions to deny access to the resource, or program instructions to discard the request.

15. A computer system for client access prioritization, the computer system comprising:
one or more computer processors;
one or more computer readable storage media; and
program instructions stored on the computer readable storage media for execution by at least one of the one or more processors, the program instructions comprising:
program instructions to assign a plurality of network addresses to a node of a network-attached storage cluster;
program instructions to receive a request to access a resource that is stored by the network-attached storage cluster and that is accessible to on the node, wherein the request identifies a network address of the plurality of network addresses;
program instructions to determine a priority of the request based, at least in part, on the network address identified by the request and further based, at least on part, on a protocol of the request; and
program instructions to process the request based, at least in part, on the priority of the request.

16. The computer system of claim 15, wherein the program instructions further comprise:
program instructions to monitor a performance condition of the node; and
program instructions to determine that the performance condition of the node violates a performance threshold and, in response, perform a corrective action.

17. The computer system of claim 16, wherein the program instructions to perform the corrective action include at least one of: program instructions to adjust an allocation of computing resources of the node from processing requests that identify a network address of the plurality of a first set of network addresses to processing requests that identify a network address of a second set of network addresses, program instructions to re-assign at least one of the plurality of network addresses of the node, and program instructions to terminate a connection by which the request was received.

18. The computer system of claim 15, wherein the plurality of network addresses includes at least one network address from a first set of network addresses and at least one network address from a second set of network addresses, wherein the first and second sets of network addresses are disjoint.

19. The computer system of claim 18, wherein the first set of network addresses has a first priority level and the second set of network addresses has a second priority level, wherein the first priority level is a higher priority than the second priority level.

20. The computer system of claim 15, wherein the program instructions to process the request further comprise at least one of: program instructions to provide access to the resource, program instructions to queue the request, program instructions to deny access to the resource, or program instructions to discard the request.
